(19) United States
(12) Patent Application Publication
(10) Pub. No.: US 2009/0307523 A1
(43) Pub. Date: Dec. 10, 2009

(54) System Performance Through Invalidation of Speculative Memory Scrub Commands

(76) Inventors: Brian D. Allison, Rochester, MN (US); Joseph A. Kirscht, Rochester, MN (US); Elizabeth A. McGlone, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 12/134,397

(22) Filed: Jun. 6, 2008

(51) Int. Cl. G06F 11/10; G06F 12/08; G06F 12/06

(52) U.S. Cl. 714/6; 711/141; 711/155; 714/E11.052; 711/E12.017; 711/E12.078

(57) ABSTRACT

A memory controller and a method for improved computer system performance invalidates (i.e., cancels or does not allow for execution of) speculative or unnecessary scrub write commands as part of the periodic execution of the overall scrub command upon the occurrence of certain events, such as if the error checking and correction (ECC) operation indicates that the data were received without error or if the ECC operation indicates that the data received have an uncorrectable error.

### BACKGROUND

The present invention relates generally to memory devices within computer systems and, more particularly, to a memory controller and a method for improved system performance through invalidation of speculative memory scrub commands.

As computer system memory capacity increasingly grows larger, performing background/patrol scrub cycles to all memory addresses in a reasonable amount of time (typically once each day) requires an increased percentage of the memory bandwidth, resulting in reduced performance of the overall computer system.

Memory scrub cycles (“scrubs”) have been performed in the prior art as atomic “read-modify-write” or “read-correct-write” operations. “Atomic” operation means that once the read-correct-write operation has started, all other accesses to memory are delayed until the scrub (i.e., the “read-correct-write”) operation is complete. From a performance perspective, these atomic operations are not highly optimal or time efficient because they require both a read and a write operation and necessary “gaps” to turn the bus around before a subsequent processor read could be dispatched (i.e., scrub read, gap, scrub write, gap, processor read).

A known improvement over the atomic read-modify-write operation is to break the operation into two non-atomic operations, placing the write command in a write queue (with dependency on read completion) and placing the read command in a read queue. This allowed for the holding off of issuing the write command until such time when the read queue is empty or has no commands that will have increased latency due to the issuing of the write command. See, for example, U.S. Pat. No. 7,257,686 (hereinafter “the '686 patent), which is incorporated by reference herein in its entirety.

However, the method disclosed in the '686 patent for memory scrubs still suffers from unnecessary memory bandwidth usage. Specifically, with the overall memory scrub command now split into two separate commands within the teachings of the '686 patent, the performance of the write command has a dependency upon the completion of the read command. There are instances when the scrub write command is still executed as part of the memory scrub, even when not needed. This results in wasted memory bandwidth. One possible method of overcoming this drawback is to disable the storeback on every scrub command (i.e., never scheduling the write), only performing reads to gather the error statistics and not performing storeback to correct any errors. However, this method does not correct for any soft errors in the memory being scrubbed.

What is needed is a memory controller and a method for improved system performance through invalidation of speculative memory scrubs commands.

### SUMMARY

The foregoing discussed drawbacks and deficiencies of the prior art are overcome or alleviated, in an exemplary embodiment, by a memory controller and a method for improved system performance which invalidates (i.e., cancels or does not allow for execution of) speculative or unnecessary scrub write commands as part of the periodic execution of the overall scrub command upon the occurrence of certain events, such as if the error checking and correction (ECC) operation indicates that the read data were received without error or if the ECC operation indicates that the read data received have an uncorrectable error.

### BRIEF DESCRIPTION OF THE DRAWINGS

Referring to the exemplary drawings wherein like elements are numbered alike in the several Figures:

FIG. 1 is a block diagram of a memory controller; and

FIG. 2, including FIGS. 2a and 2b, is a flow diagram of a method for scrubbing memory executed by the memory controller of FIG. 1 in accordance with an exemplary embodiment of the present invention.

### DETAILED DESCRIPTION

Disclosed herein is a memory controller and a method for improved system performance through invalidation of speculative memory scrub commands. Briefly stated, the scrub write command is always scheduled as a way of maintaining coherency within the memory scrub operation, but the scrub write command is deemed “speculative” or is cancelled or invalidated in certain situations; specifically, if the data do not have an error or if the data have an uncorrectable error.

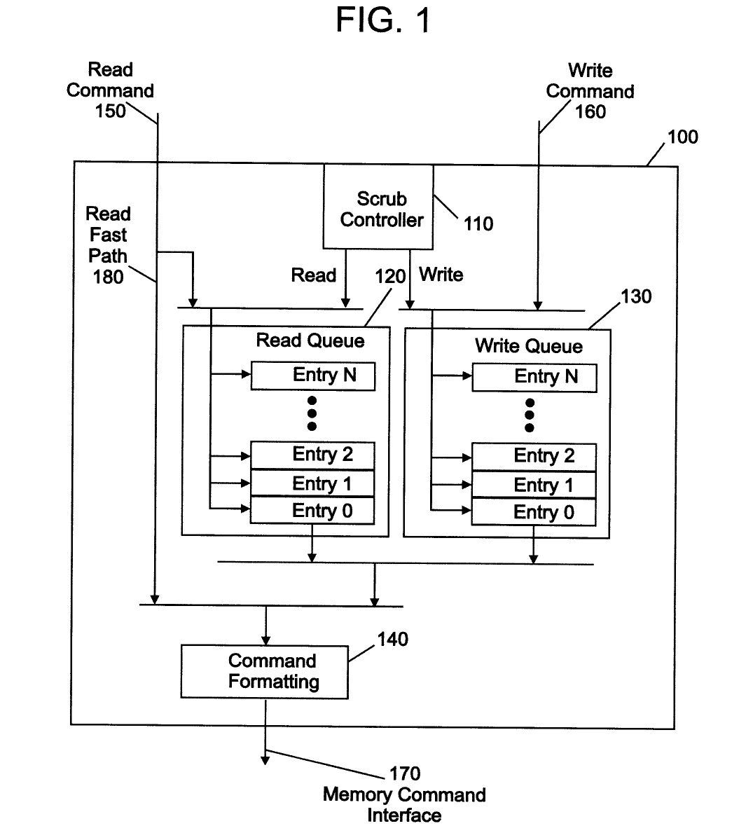

Referring to FIG. 1, there illustrated is a block diagram of a memory controller 100. The controller 100 may be somewhat similar to that illustrated in FIG. 1 of the '686 patent. The memory controller 100, which it typically part of a processor or computer system, may be utilized in an exemplary embodiment of the present invention, as described in more detail hereinafter. The memory controller 100 includes a scrub controller 110, a read queue 120, a write queue 130, and command formatting logic 140. A read command 150 from a processor may be written to the read queue 120, or may alternatively be passed via the fast read path 180 to the command formatting logic 140. The read queue 120 includes a plurality of entries that are processed by the memory controller 100. A write command 160 from the processor may be written to the write queue 130. The write queue 130 includes a plurality of entries that are processed by the memory controller 100. In the memory controller 100, read operations typically have priority over write operations, such that the read queue 120 is serviced until all its entries have been processed or priority shifts to favor writes for cases such as write queue nearly or completely full or a read collision against a pending write, at which time one or more entries in the write queue 130 may be processed. The command formatting logic 140 presents appropriate commands to the memory via the memory command interface 170.

The scrub controller 110 as part of the memory controller 100 includes the logic, embodied in hardware or software, to perform scrub cycles when needed (e.g., at periodic intervals such as once per day), typically during times when it is more likely that other “normal” memory accesses may not be not pending. The scrub controller 110 has a read interface for writing to the read queue 120 and a write interface for writing to the write queue 130. As mentioned hereinabove, the memory controller of the '686 patent represents an improvement over the atomic read-modify-write operation common in the prior art. The '686 patent breaks the prior art atomic operation into two non-atomic operations, placing the write in the write queue 130 (with dependency on read completion) and the read in the read queue 120. This allows for holding off on issuing the scrub write command until such time when the read queue is empty or has no commands that will have increased latency due to issuing the scrub write command.

The present invention represents an improvement over the operation of the memory controller of the '686 patent. Specifically, the memory controller 100 implements a method in accordance with a preferred embodiment of the present invention in which the scrub write command is invalidated (i.e., cancelled or not allowed to execute) upon the occurrence of certain events, such as if the ECC operation indicates that the read data were received without error or if the ECC operation indicates that the read data received have an uncorrectable error. By not executing the scrub write command at certain “speculative” times, unnecessary memory bandwidth usage is avoided to a certain extent.

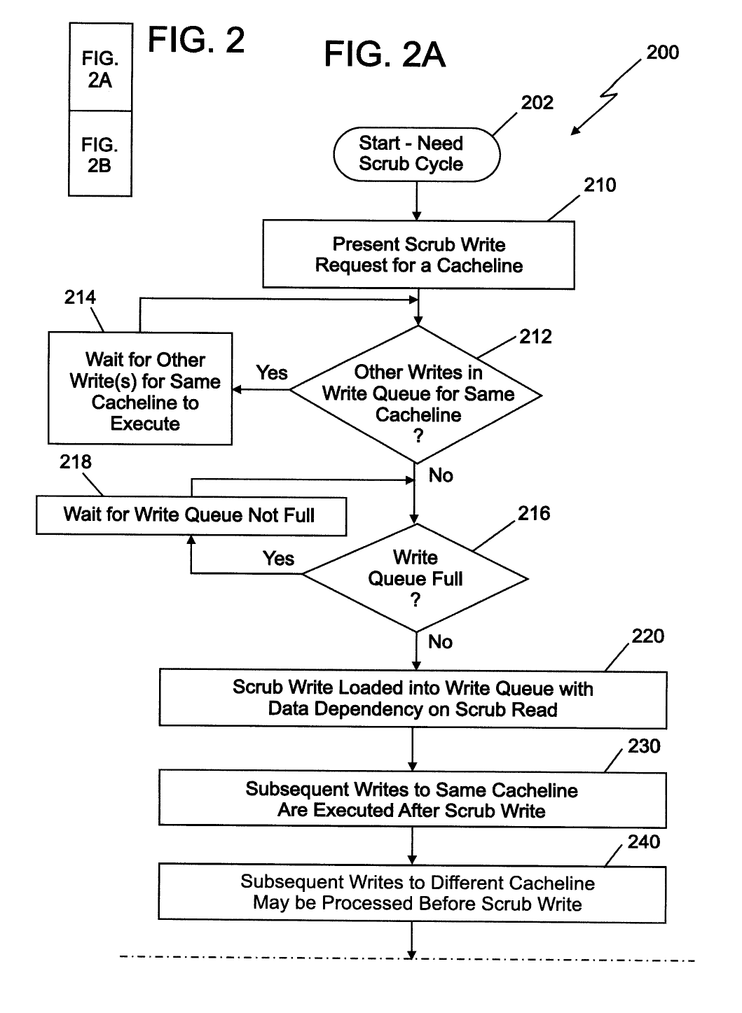

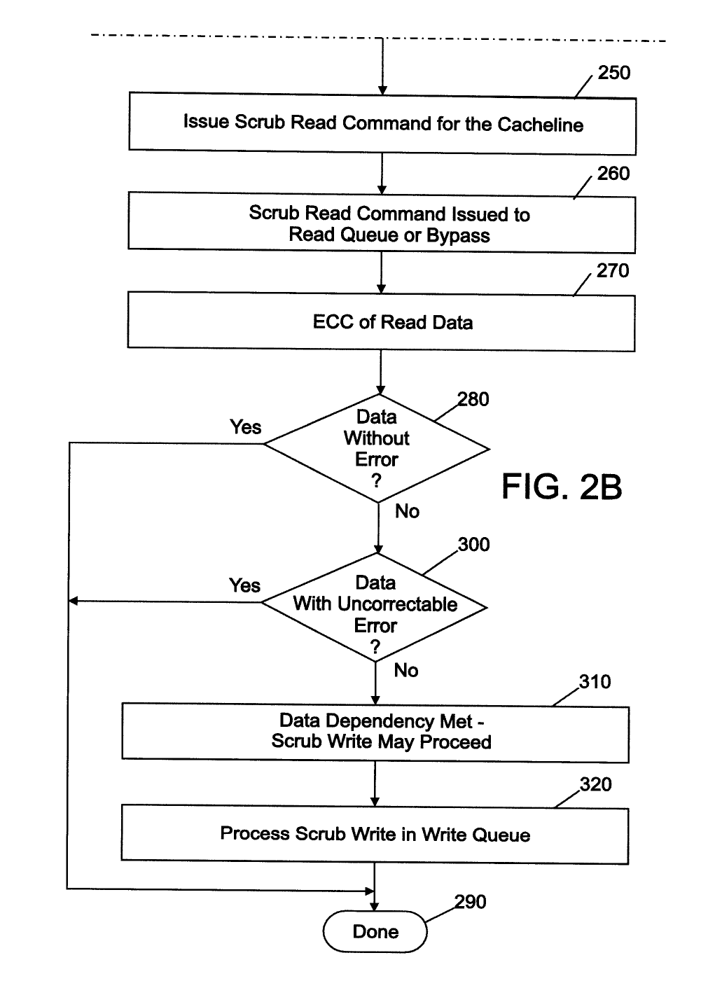

The logic within the scrub controller 110 implements an exemplary embodiment of a method in accordance with the present invention. Referring to FIG. 2, there illustrated is a flow diagram of the exemplary method for scrubbing memory. The method may be embodied in hardware and/or software, depending on the configuration of the scrub controller 110. The method of FIG. 2 is somewhat similar to that illustrated in FIG. 2 of the '686 patent. However, there are some important differences, as described in detail hereinafter, resulting in improved (e.g., faster) operation of the memory controller 100 and also of the processor or computer system that the controller 100 is a part of.

In FIG. 2, the method 200 for performing a scrub cycle begins when a scrub cycle is needed or is scheduled in a step 202. The scrub controller 110 presents a scrub write request for a cacheline to the write queue 130 in a step 210. If there are other writes in the write queue 130 for the same cacheline (step 212=YES), the method 200 waits in a step 214 until all other writes to the same cacheline have been executed. At this point, there are no other writes in the write queue 130 for the same cacheline (step 212=NO). If the write queue 130 is full (step 216=YES), the method 200 waits in a step 218 until the write queue is not full. Once the write queue 130 is not full (step 216=NO), a scrub write command is loaded in a step 220 into the write queue 130 with a specified data dependency on a scrub read command that has not yet been issued. A latch with an output NeedDDone (need data done) may be provided as part of the memory controller 100 to indicate when data for a pending read are not yet in the memory controller's central data buffer. Once the data are read into the central data buffer, the NeedDDone latch is cleared to indicate that the data dependency has been satisfied. The '686 patent recognized that the presence of the NeedDDone signal allows implementing a scrub cycle in a way that does not use explicit atomic operations, such as the read-correct-write cycle of the prior art.

Once the scrub write is written to the write queue 130 in the step 220, the memory controller 100 assures in a step 230 that subsequent writes to the same cacheline are not executed before the scrub write. The memory controller 100 also assures in a step 240 that subsequent writes to different cachelines may be processed before the scrub write is processed, because the scrub write does not affect the other pending writes to different cachelines. The scrub controller 110 then issues a scrub read command for the cacheline in a step 250. The scrub read command is issued in a step 260 to the read queue 120 or to the read fast path (bypass) 180. Next, an error checking and correction (ECC) operation is performed on the read data in a step 270. In this exemplary embodiment, enough cycles are given after receipt of the read data to allow the ECC operation to complete. As part of the ECC operation in the step 270, the read data may be processed to check and correct for certain types of correctable errors, and the processed data are written to the central data buffer.

At this point, the method 200 of the present invention diverges from the method of FIG. 2 of the '686 patent. After the ECC operation has corrected certain types of correctable errors in the step 270, the method 200 checks in a test 280 whether the read data were received without error. If the result is YES (i.e., the read data are “clean”), then the method 200 ends in a step 290 without issuing the scrub write command. When the ECC operation on the read data indicates that the data are clean, invalidating the scrub write command results in improved performance through reduction in wasted memory bandwidth due to the unnecessary execution of the “speculative” scrub write command. Also, there is a potential reduction in wasted memory bandwidth due to the unnecessary “gap” cycles on the memory bus to transition from read to write to read. Note that if the scrub write command is performed with other write commands, the gaps are needed. Also, there is a potential reduction in the effects that the scrub write has on impacting reads simply because it is occupying a write queue entry. As the number of write queue entries increases, writes are allowed to begin affecting reads so as to prevent the write queue from filling up and causing snoop stalls on the front side bus. Finally, not performing the scrub write allows the central data buffer in which the scrub read data resides to be returned back to the central pool of buffers.

If the result of the test 280 is NO, then another test 300 is executed where the received read data are checked for an uncorrectable error. If the result of the test 280 is YES, then the method ends in the step 290 without issuing the scrub write command. When the ECC operation on the read data indicates that the data have an uncorrectable error, invalidating the scrub write command will prevent the bad data in memory from being overwritten with bad data with good ECC. This is important for several reasons. Debugging the problem after the system has machine checked is difficult. A subsequent fetch of the failing address location will be misleading in isolating whether the error is in the DRAM or if it occurred in flight back to the controller. Also, if the error occurs on the ECC checkbits, storing the data back with newly generated ECC data will make the data look good in memory. If memory mirroring mode is enabled, incurring an uncorrectable error on a scrub is not a machine check condition. Should a real processor fetch hit the same address, the system can recover by simply re-issuing the memory fetch to the complement memory port. However, if the scrub write stores bad data with good ECC, a processor fetch to that location will result in a data integrity error.

Thus, while the tests 280, 300 are illustrated as being separate operations, they can both considered to be part of the ECC operation, which may be started in the step 270. In addition, any initial check for correctable errors in the read data may not be performed in the ECC operation step 270, but instead may be deferred until the test 280 and may be made a part thereof. If the result of the tests 280 and 300 indicate that the only type of error detected is a correctable error, then the read data may be processed to correct certain types of correctable errors, and the processed data are written to the central data buffer, all in a step 310.

If the result of the test 300 is NO, and if the processed data are written to the central data buffer in the step 270 or the step 310 for the correctable error situation, the data dependency for the scrub write in step 220 has now been met. Thus, a signal is generated in the step 310 that the pending scrub write operation may proceed. In an exemplary embodiment, this is accomplished by the NeedDDone latch being cleared once the data for the cacheline are written to the central data buffer. Since the data dependency has been met, the scrub write may now be performed in a step 320. Thus, the scrub write command is not invalidated or cancelled and is allowed to proceed if the ECC operation in the step 270 or the step 310 indicates that a correctable data error was detected (and the data error was corrected), thus allowing the error residing in memory to be rewritten with the corrected data. The method 200 then ends in the step 290.

Advantages of the memory controller and method of the present invention include the fact that invalidating the scrub write on clean data will improve performance of the memory controller 100 and the system that the controller 100 operates in. Also, invalidating the scrub write on an uncorrectable error will facilitate easier debug and, when operating in Memory Mirroring mode, will prevent Data Integrity errors.

The disclosure hereinabove has taught that the scrub write command can be invalidated from the write queue in two different occasions: (1) if the ECC operation indicates that the read data were received without error; or (2) if the ECC operation indicates that the data were received and have an uncorrectable error. However, the present invention is not limited to these two specific types of occurrences regarding the received read data. Other possible scenarios exist in which the scrub write is invalidated, wherein such alternative scenarios may be obvious to one of ordinary skill in the art in light of the teachings herein. Also, the method of the present invention is not limited to executing both test operations 280, 300. Only one of these two test operations 280, 300 may be executed.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for scrubbing a memory, comprising:
(a) presenting a scrub write request to a cacheline that includes a specified address in a memory;
(b) waiting for any writes to the same cacheline that are in a write queue to execute;
(c) loading a scrub write command into the write queue specifying a data dependency on a subsequent scrub read command;
(d) issuing a scrub read command to read data from the specified address;
(e) checking the read data for an error; and
(f) if no error is found in the read data, then invalidating the scrub write command.

2. The method of claim 1, further comprising:
if an error is found in the read data that is correctable, then processing the read data to correct the correctable error;
indicating that the data dependency is satisfied; and
the scrub write command writing the processed data to the specified address.

3. The method of claim 1, further comprising:
after checking the read data for an error, if an error is found, then checking the read data for an uncorrectable error; and
if the read data contains an uncorrectable error, then invalidating the scrub write command.

4. The method of claim 1, further comprising:
after checking the read data for an error, if an error is found, then determining if the error is an uncorrectable error; and
if the error is an uncorrectable error, then invalidating the scrub write command.

5. The method of claim 1, wherein loading the scrub write command into the write queue specifying a data dependency on a subsequent scrub read command is performed if the write queue is not full.

6. The method of claim 1, further comprising requiring any subsequent write to the same cacheline to be performed after the scrub write command is complete.

7. A memory controller, comprising:
a write queue that receives write commands;
a scrub controller that presents a scrub write request to a cacheline that includes a specified address in a memory;
in response to the scrub write request presented by the scrub controller, the memory controller waits for any writes to the same cacheline that are in the write queue to execute and loads a scrub write command into the write queue specifying a data dependency on a subsequent read command;
wherein the scrub controller issues a scrub read command to read data from the specified address, and wherein in response to the scrub controller issuing the scrub read command, the memory controller checks the read data for an error and if no error is found, the memory controller invalidates the scrub write command.

8. The memory controller of claim 7, wherein if an error is found in the read data that is correctable, then the memory controller processes the read data to correct the correctable error, indicates that the data dependency is satisfied, and processes the scrub write command in the write queue to write the processed data to the specified address.

9. The memory controller of claim 7, wherein after the memory controller checks the read data for an error, if an error is found, then the memory controller checks the read data for an uncorrectable error; and if the read data contains an uncorrectable error, the memory controller invalidates the scrub write command.

10. The memory controller of claim 7, wherein after the memory controller checks the read data for an error, if an error is found, then the memory controller determines if the error is an uncorrectable error and if the error is an uncorrectable error, the memory controller invalidates the scrub write command.

11. The memory controller of claim 7, wherein the memory controller loads the scrub write command into the write queue if the write queue is not full.

12. The memory controller of claim 7, wherein the memory controller waits for any subsequent writes to the same cacheline to be performed after the scrub controller issues the scrub write command.

13. The memory controller of claim 7, wherein the memory controller waits for any subsequent writes to a different cacheline to be performed after the scrub controller issues the scrub write command.

14. A method for scrubbing a memory, comprising:
(a) presenting a scrub write request to a cacheline that includes a specified address in a memory;
(b) waiting for any writes to the same cacheline that are in a write queue to execute;
(c) loading a scrub write command into the write queue specifying a data dependency on a subsequent scrub read command;
(d) issuing a scrub read command to read data from the specified address;
(e) checking the read data for an uncorrectable error; and
(f) if an uncorrectable error is found in the read data, then invalidating the scrub write command.

15. The method of claim 13, further comprising:
if an uncorrectable error is not found in the read data, then indicating that the data dependency is satisfied; and
the scrub write command writing the processed data to the address in memory.

16. The method of claim 13, further comprising:
if after checking the read data for an uncorrectable error an error is found in the read data that is correctable, then processing the read data to correct the correctable error;
indicating that the data dependency is satisfied; and
the scrub write command writing the processed data to the specified address.

17. The method of claim 13, wherein loading the scrub write command into the write queue specifying a data dependency on a subsequent scrub read command is performed if the write queue is not full.

18. A method for scrubbing a memory, comprising:
(a) presenting a scrub write request to a cacheline that includes a specified address in a memory;
(b) waiting for any writes to the same cacheline that are in a write queue to execute;
(c) loading a scrub write command into the write queue specifying a data dependency on a subsequent scrub read command;
(d) issuing a scrub read command to read data from the specified address;
(e) checking the read data for an error;
(f) if no error is found in the read data, then invalidating the scrub write command;
(g) if an error is found in the read data, then checking the read data for an uncorrectable error; and
(h) if the read data contains an uncorrectable error, then invalidating the scrub write command;
(i) if an error is found in the read data that is correctable, then processing the read data to correct the correctable error;
(j) indicating that the data dependency is satisfied; and
(k) the scrub write command writing the processed data to the specified address.

19. The method of claim 18, wherein loading the scrub write command into the write queue specifying a data dependency on a subsequent scrub read command is performed if the write queue is not full.

20. The method of claim 18, further comprising requiring any subsequent write to the same cacheline to be performed after the scrub write command is complete.
